(19) United States
(12) Patent Application Publication
(10) Pub. No.: US 2026/0002569 A1
(43) Pub. Date: Jan. 1, 2026

(54) METHOD FOR OPERATING A DRUM BRAKE, CONTROL UNIT, AND FRICTION BRAKE

(71) Applicant: Robert Bosch GmbH, Stuttgart (DE)

(72) Inventors: Simon Peter, Weil Der Stadt (DE); Daniel Stuemke, Murrhardt (DE); Michael Janhsen, Stuttgart (DE)

(21) Appl. No.: 19/195,752

(22) Filed: May 1, 2025

(30) Foreign Application Priority Data
Jun. 28, 2024 (DE) 10 2024 206 040.2

(51) Int. Cl. F16D 65/22; F16D 66/00; F16D 121/24

(52) U.S. Cl. CPC F16D 65/22; F16D 66/00; F16D 2066/005; F16D 2121/24

(57) ABSTRACT

A method for operating an electromechanical drum brake including at least two brake shoes of a motor vehicle. In the method, a static force-path characteristic curve of the brake shoes for increasing and decreasing the braking force is ascertained as a hysteresis curve when the motor vehicle is at a standstill; at least one stiffness and one friction value of at least one of the brake shoes are ascertained as parameters as a function of a course of the static force-path characteristic curve; as a function of the ascertained parameters, a dynamic force-path characteristic curve is ascertained using a physical substitute model of the drum brake, and for satisfying a braking request, the drum brake is controlled as a function of the dynamic force-path characteristic curve.

### CROSS REFERENCE

The present application claims the benefit under 35 U.S.C. § 119 of German Patent Application No. DE 10 2024 206 040.2 filed Jun. 28, 2024, which is expressly incorporated herein by reference in its entirety.

### FIELD

The present invention relates to a method for operating an electromechanical drum brake comprising at least two brake shoes, in particular a simplex brake, duplex brake, or servo brake, of a motor vehicle.

Furthermore, the present invention relates to a control unit specifically configured to perform the above-described method when used as intended. In addition, the present invention relates to an electromechanical drum brake for a motor vehicle, in particular a simplex brake, duplex brake, or servo brake, comprising at least two brake shoes, wherein, for displacing the brake shoes, the drum brake comprises an actuator assembly with a controllable electric machine.

### BACKGROUND INFORMATION

Conventional motor vehicles generally use hydraulically actuatable friction brakes comprising brake shoes that interact with a brake disk, wherein the brake shoes are pressed opposite each other laterally against the end face of the brake disk in order to cause deceleration. In hydraulic friction brakes, a pressure sensor is typically used in the hydraulic system to monitor the clamping force and thus the braking force of the friction brake in order, for example, to estimate and control the braking torque. Uncertainties in the friction pairing represent a decisive limitation on the accuracy of the braking torque estimate.

Changed boundary conditions, which currently arise in particular due to the electrification of motor vehicles, may also make the use of electromechanically actuated brakes attractive. However, the question as to a suitable sensor system for ascertaining the braking torque has not yet been definitively decided. The effort for a sensor system suitable for this purpose is increased in comparison to hydraulic brake systems, also because, in the case of electromechanical brake systems, the braking force on each individual wheel must be ascertained by an actuator.

### SUMMARY

A method according to the present invention may have the advantage that significantly improved accuracy of the drum brakes is ensured in comparison to the conventional solution. For this purpose, the method according to the present invention provides an advantageous calibration routine, which makes optimal control of the drum brake possible, in particular also during travel of the motor vehicle.

According an example embodiment of the present invention, it is provided for this purpose that a static force-path characteristic curve of the brake shoes for increasing and decreasing the braking force is initially ascertained as a hysteresis curve when the motor vehicle is at a standstill, wherein at least one stiffness and one friction value of at least one of the brake shoes are ascertained as parameters as a function of a course of the static force-path characteristic curve, wherein, as a function of the ascertained parameters, a dynamic force-path characteristic curve is ascertained by means of a physical substitute model of the drum brake, and wherein, for satisfying a braking request, the drum brake is controlled as a function of the dynamic force-path characteristic curve.

This calibration routine thus advantageously transfers the force-path characteristic curve ascertained at standstill to the dynamic state or driving state of the motor vehicle. In particular, this remedies the deficiency that the force-path characteristic curve measured in the static case in drum brakes deviates significantly from the dynamic force-path characteristic curve that predominates later in operation. However, direct measurement of the dynamic characteristic curve is not readily possible since this would lead to severe deceleration of the motor vehicle. Predicting or ascertaining the dynamic force-path characteristic curve without an actual braking process during travel is therefore clearly advantageous. Preferably, the static force-path characteristic curve is ascertained before the motor vehicle moves for the first time after startup, for example by turning on the ignition. In particular, the static force-path characteristic curve is ascertained each time before the motor vehicle moves for the first time after the ignition is turned on. Parameters for the physical substitute model that can be used to estimate the dynamic force-path characteristic curve as well as other variables during travel can be identified from the ascertained static force-path characteristic curve. This improves the control quality of the drum brake and thus increases safety and comfort. At the same time, high cost efficiency is provided since the advantageous method does not require the use of expensive sensor systems to ascertain the dynamic force-path characteristic curve.

According to a preferred development of the present invention, it is provided that the static force-path characteristic curve is ascertained as a function of an actuation force and an actuation path of the brake shoes. This makes it possible to determine the static force-path characteristic curve in a simple manner because the parameters necessary for determining the actuation force and the actuation path are usually already known to a control unit of the motor vehicle.

According to an example embodiment of the present invention, it is thus preferably provided that a motor current of an actuator assembly of the drum brake is monitored for determining the actuation force, and/or that a rotor position of an actuator assembly of the drum brake is monitored for determining the actuation path. In the case of electromechanical actuator assemblies, the motor current and rotor position, in particular in the form of the rotor angle, are generally already monitored by the control unit in order to be able to adjust and control the actuation force and the actuation path in a specific manner. Often times, these parameters are therefore already present and can advantageously be used for determining the force-path characteristic curve.

Furthermore, according to an example embodiment of the present invention, it is preferably provided that the braking force is increased and/or decreased by controlling the actuator assembly with a specified desired profile for the motor current, wherein the motor current is in particular increased and/or decreased abruptly and/or has a modulated periodic component. The specified desired profile ensures that the static force-path characteristic curve is determined reliably. The static force-path characteristic curve can be ascertained, in particular in the case of a current-controlled actuation of the actuator assembly, by abruptly increasing or correspondingly abruptly decreasing the motor current, in particular in the manner of a current ramp. If the actuator assembly is operated by position control, the motor current is advantageously specified with a modulated periodic component in order to ascertain the force-path characteristic curve.

Furthermore, according to an example embodiment of the present invention, it is preferably provided that a stiffness in the normal direction, a stiffness in the tangential direction, a dynamic friction value, and/or a static friction value of at least one of the brake shoes are ascertained as parameters. This is based on the assumption that the stiffness in the normal direction, the stiffness in the tangential direction, and the friction value (dynamic friction value or static friction value) dominate the force-path characteristic curve or rather the characteristic of the force-path characteristic curve. By taking these parameters into account, the static force-path characteristic curve and thus also the dynamic force-path characteristic curve are therefore advantageously determinable.

Preferably, according to an example embodiment of the present invention, a first point for the static characteristic curve is selected or specified and the braking force is increased only to the first point.

Preferably, according to an example embodiment of the present invention, the first point is specified as a function of a maximum value of a braking force, wherein the point is before the maximum value, in particular in a region of at least approximately constant slope of the characteristic curve, and is in particular mapped to the maximum value.

Furthermore, according to an example embodiment of the present invention, it is preferably provided that at least a second point is determined on the static force-path characteristic curve in the region of the braking force decrease, wherein the second point is in particular mapped to a maximum gradient of a slope of the characteristic curve.

Furthermore, according to an example embodiment of the present invention, it is preferably provided that at least one of the parameters is ascertained as a function of the first and/or the second point. In particular, the parameters are calculated or, where possible, measured.

Preferably, according to an example embodiment of the present invention, at least one of the parameters is ascertained as a function of at least one distance between a pivot point of the corresponding brake shoe and a force application point of the actuator assembly, and/or between a pivot point of the brake shoe and a contact point of the brake shoe with the brake drum of the drum brake. It can be assumed that the geometric arrangement and design of the drum brake does not change considerably over the service life.

Furthermore, according to an example embodiment of the present invention, it is preferably provided that an overall stiffness of the drum brake is ascertained, in particular by means of the physical substitute model, as a function of the ascertained stiffnesses of the brake shoes, and that the dynamic force-path characteristic curve is ascertained or determined as a function of the overall stiffness. Preferably, the stiffnesses and in particular the overall stiffness are updated regularly, for example after each startup (=ignition on) of the motor vehicle in order to ensure optimal control of the drum brake permanently and to detect signs of wear on the drum brake.

The control unit according to the present invention is specifically configured to perform the method according to the present invention when used as intended. This results in the aforementioned advantages.

The drum brake according to the present invention is characterized by the control unit according to the present invention. This results in the aforementioned advantages.

Further advantages and preferred features and feature combinations result in particular from what was described above and in the rest of the disclosure herein. The present invention is explained in more detail below with reference to the figures.

### BRIEF DESCRIPTION OF THE DRAWINGS

FIG. 1 shows an advantageous drum brake in a simplified illustration, according to an example embodiment of the present invention.

FIG. 2 shows a parameter model of a brake shoe of the drum brake, according to an example embodiment of the present invention.

FIG. 3 shows a free-body diagram of the parameter model of the brake shoe, according to an example embodiment of the present invention.

FIG. 4 shows a static force-path characteristic curve of the drum brake, according to an example embodiment of the present invention.

FIG. 5 shows a static and a dynamic force-path characteristic curve of the drum brake, according to an example embodiment of the present invention.

FIGS. 6A and 6B shows forces acting on the drum brake, in different operating states of the drum brake.

FIG. 7 shows a graphical derivation of parameters of the drum brake for determining the dynamic force-path characteristic curve, according to an example embodiment of the present invention.

### DETAILED DESCRIPTION OF EXAMPLE EMBODIMENTS

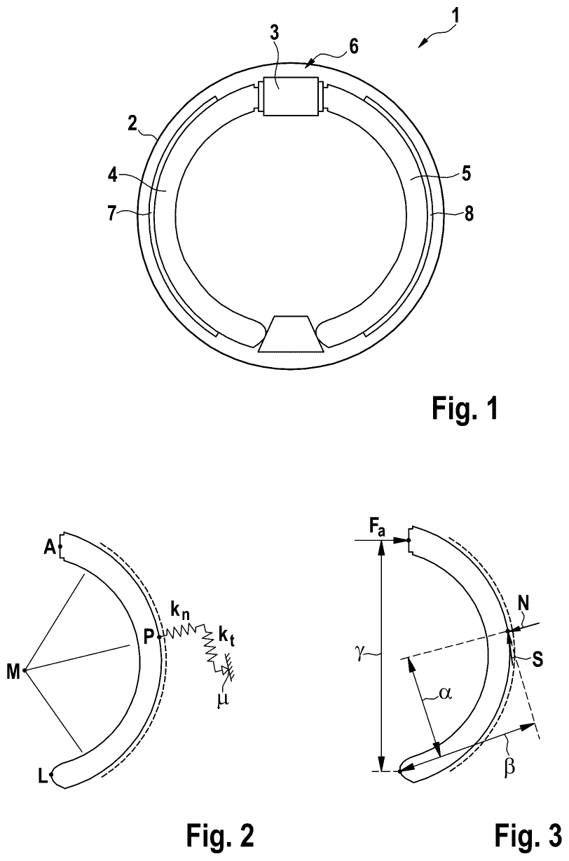

In a simplified illustration, FIG. 1 shows an advantageous drum brake 1 of a motor vehicle not shown in more detail here. In the present case, the drum brake 1 is designed as a simplex brake. Alternatively, according to further embodiment examples, the drum brake is designed as a duplex brake or a servo brake. In any case, the drum brake 1 comprises a brake drum 2, a spreading unit 3, and two brake shoes 4, 5, which can be spread by the spreading unit 3, are located in the drum 2, and can be pressed against the inner side of the drum 2 by the spreading unit 3. The spreading unit 3 is part of an actuator assembly 6, which also comprises an electric machine not shown in more detail here, which can be controlled to actuate the spreading unit 3 in order to press the brake shoes 4, 5 against the inner side of the brake drum 2. By spreading the brake shoes 4, 5, a brake pad 7, 8 attached to the brake shoes is brought into contact with the inner side of the brake drum 2, whereby frictional contact occurs, which, when the drum 2 rotates relative to the brake shoes 4, 5, decelerates this rotation, or braking occurs.

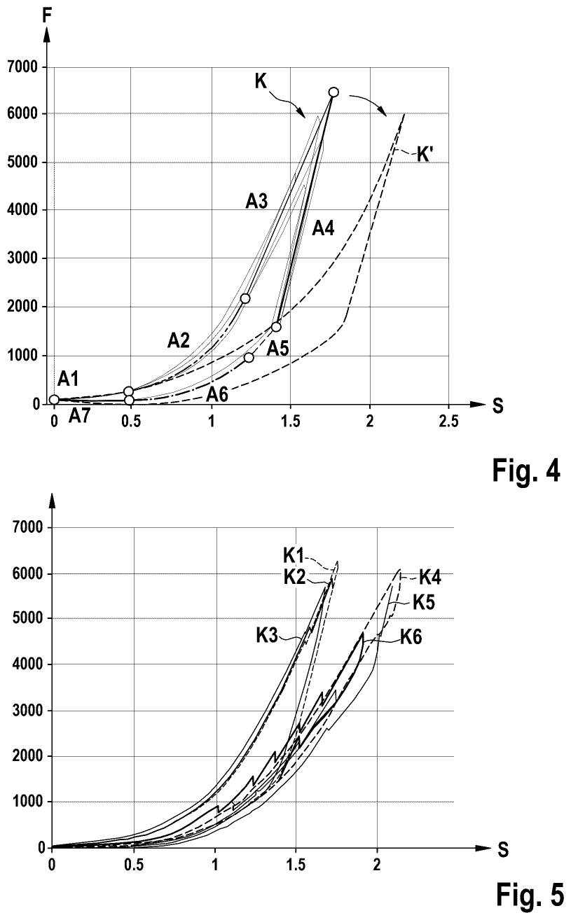

In the case of electromechanical activation, the spreading unit 3 in particular comprises a converter, for example a ball screw drive, cam drive, or the like, which converts implements the rotation of the electric motor into a linear movement. In order to spread the brake shoes 4, 5, a certain spread path s is required, which must be set depending on a desired braking force F. The relationship between the force F and the path s is described by the so-called force-path characteristic curve, as illustrated, by way of example, in FIG. 4.

Optionally, a current-angle characteristic curve of the electric motor of the actuator assembly is used instead of the force-path characteristic curve, wherein the current is proportional to the torque of the motor (and thus, after the rotation-translation conversion, to the force) and the angle is proportional to the spread path of the actuator assembly 6. The advantage of this procedure is that an additional sensor system for detecting the force and/or path can be dispensed with.

Since the force-path characteristic curve K of the drum brake 1 depends on various parameters and environmental factors, in particular on wear and temperature, an estimate of the actual braking force present and its control on the basis of the estimated braking force is possible only if the drum brake 1 or its control routine have been calibrated beforehand. The measurement of a dynamic force-path characteristic curve during travel is not possible because this would produce a braking torque that is to be avoided both for comfort reasons and for safety reasons.

The drum brake 1 is therefore preferably calibrated before the vehicle starts to move. A static force-path characteristic curve K is recorded when the motor vehicle is at a standstill, and converted into a dynamic force-path characteristic curve K′ by means of a physical substitute model of the drum brake, which dynamic force-path characteristic curve is then used during driving operation of the drum brake to control the braking force. How the dynamic force-path characteristic curve K′ can be ascertained on the basis of the static force-path characteristic curve K is explained below. The static force-path characteristic curve K and the dynamic force-path characteristic curve K′ are shown in simplified form in FIG. 4.

As already mentioned, before the vehicle starts to move, the actuator assembly 6 is controlled to spread the brake shoes 4, 5 from the rest position in the standing vehicle so that a high braking force is built up. Advantageously, the entire range of force of the actuator should be traversed. During the subsequent decrease in force, the motor current of the electric motor is reduced, whereby the electric motor moves back, in particular due to the elasticity of the drum brake. The force-path characteristic curve can be constructed by mapping the motor current and the motor rotation angle during the quasi-static increase and decrease of the braking force. If necessary and possible, current is supplied to the electric motor the other way around in order to generate a negative force or to accelerate the decrease in force.

For explaining the occurring effects of the subsequent conversion of the static into the dynamic force-path characteristic curve, a 3-parameter model of the brake shoes 4, 5 is proposed for simplicity, which FIG. 2 shows in simplified form. It is assumed that the following three parameters dominate the characteristic of the static and of the dynamic force-path characteristic curve:
kₙ=pad stiffness in the normal direction
kₜ=pad stiffness in the tangential direction
μ=friction value (pad/drum)

For simplicity, each brake pad 7, 8 is assumed to be linear elastic, as a result of which it can be represented in the center of pressure of the friction surface 7, 8 by the two stiffnesses or springs in the normal direction kₙ and in the tangential direction kₜ. In addition, each pad 7, 8 can slip along the brake drum 2, i.e., in the tangential direction. A friction value μ is assumed in the friction surface. This model results in the forces shown in the partial cutaway view in FIG. 3, which forces act on the corresponding brake shoe 4, 5:
Fₐ=actuation force
N=normal force
S=shear force

At the actuation point A, a static characteristic curve results, which has the qualitative course shown in FIG. 7.

FIG. 4 shows the static force-path characteristic curve K with characteristic regions. The characteristic curve results as a hysteresis loop, with an upper branch showing the increase in force and a lower branch showing the decrease in force of the drum brake 1. The hysteresis curve results in particular from the friction in the actuator assembly 6 itself as well as from the stiffnesses of the drum brake 1, in particular of the brake shoes 4, 5. A run through the static force-path characteristic curve substantially consists of seven phases A1 to A7 separated from one another by the characteristic points illustrated by circles in FIG. 4:
A1=decreasing the air gap
A2=applying the pads (non-linear)
A3=linear force increase (pads fully applied)
A4=steep linear force decrease (pads fully applied)
A5=linear force decrease (pads fully applied)
A6=releasing the pads (non-linear)
A7=increasing the air gap

The braking force is in particular increased and/or decreased by controlling the actuator assembly 6 with a specified desired profile for the motor current, wherein the motor current is increased and/or decreased abruptly, for example in the form of a current ramp, in a, for example for a, current control and/or has a modulated periodic component for a position control. The static force-path characteristic curve differs greatly from the dynamic force-path characteristic curve, which is particularly relevant for operation. In particular, increased stiffness and hysteresis are observed in the static case.

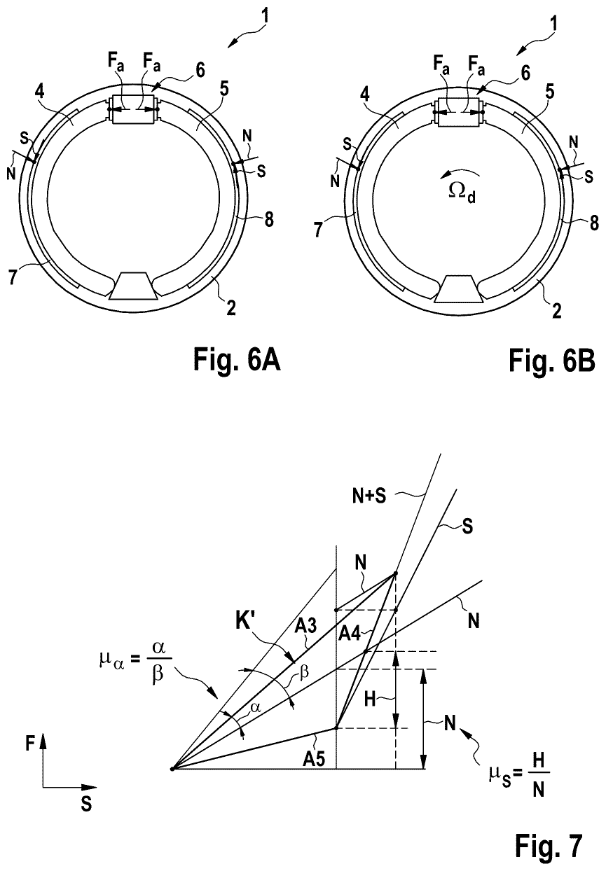

In this context, FIG. 5 shows multiple force-path characteristic curves K1 to K6, wherein the force-path characteristic curves K1 to K3 show the static case with different forces and the force-path characteristic curves K4 to K6 show the dynamic case with different braking forces. A shift of the characteristic curve from the static case to the dynamic case can clearly be seen. In the present case, it is assumed that this is due to a generally different shear stress distribution in the corresponding friction surface or in the contact area between the brake shoes 4, 5 and the brake drum 2. This effect is shown in FIGS. 6A and 6B for illustration. FIGS. 6A and 6B show the drum brake 1 in the static case (FIG. 6A) and in the dynamic case (FIG. 6B). The shear forces S caused by friction generally oppose the movement of the brake shoes 4, 5 along the friction surface. In the dynamic case according to FIG. 6B, the rotational speed Ωd of the brake drum (Ωd≠0) exerts an impressed friction force on both brake shoes 4, 5. Both brake shoes 4, 5 are thereby taken in the same circumferential direction, which means that one of the forces S opposes the actuation force Fₐ of the spreading unit 3. The other one acts in the direction of the actuation force Fₐ. This behavior is also known in drum brakes 1 as the leading and the trailing brake shoe.

In the static case according to FIG. 6A, the shear stresses are different because the brake drum 2 is stationary and the shear forces S thus result exclusively from the movement of the brake shoes 4, 5 relative to the brake drum 2 as a result of the spreading. In this case, both shear forces S oppose the actuation force F_{A}. Accordingly, the actuation force necessary to compress the pad material changes from the static to the dynamic case. The characteristic curve in the dynamic case is thus generally gentler.

In order to identify this effect and relevant dependencies quantitatively and without an additional sensor system, the parameter model shown in FIG. 2 is used in a physical substitute model of the drum brake 1. This physical substitute model in particular takes into account the structure of the drum brake with respect to its dimensions and geometric ratios, wherein with respect to the arrangement and mounting of the brake shoes 4, 5. The actuation force F_{A} is described as a function of the normal force N and the shear force S as well as the geometric parameters α, β, γ, as shown in FIG. 3, and results in

$$F = \frac{N * α + S * β}{γ}$$

The proposed substitute model is only valid for the fully applied state, in which there is an approximately uniform surface pressure on the entire friction pad 7, 8. In comparison to the actually measured characteristic curve, i.e., the static force-path characteristic curve, the air gap and the non-linear application or release of the brake shoes 4, 5 are therefore not considered. This in particular eliminates the phases A1, A2, A6, and A7. Identifying the linear phases A3, A4, and A5 from an actual measurement and extending the phases A3 and A5 to the common intersection point results in the simplified static force-path characteristic curve K, which is shown in FIG. 7.

The three model parameters kₙ, kₜ and μ are preferably ascertained from the simple force-path characteristic curve K′. The procedure is as follows:
The normal stiffness kₙ is ascertained by constructing a midpoint of phase A4. At the midpoint of phase A4, the shear stresses S change sign, assuming that exclusively static friction occurs in this phase.
The tangential stiffness kₜ is ascertained in phase A4 by eliminating the normal stiffness kₙ.
With knowledge of the normal stiffnesses, the dynamic friction value μ_{d} can be ascertained by angle comparison in the phases A3 or A5.
The static friction value μₛ can be ascertained by comparing the static friction force achieved in phase A4 in comparison with the acting normal force.

The differentiation between dynamic and static friction value is optional and is only performed in the case of corresponding measurement accuracy. In particular, it is also taken into account for the force H transferable by static friction. Wherein the dynamic friction value results from the ratio N/H of the normal force N to the force H, and the static friction value preferably results from the ratio α/β of the parameters α and β, as also shown in FIG. 7.

Preferably, in the phases A3 and A5, stick-slip effects are avoided and, if they cannot be avoided, it is ensured that they are the same for increasing and decreasing. In particular, a constant loading speed is used for this purpose. It is also preferably assumed that the brake shoes 4, 5 slip in phase A1 and A3 and stick to the brake drum 2 in phase A2, and that the contact center point between the brake pad 7, 8 and the brake drum 2 does not change. It is also assumed that the friction value μ does not change.

With the obtained parameters, depending on the embodiment of the drum brake 1, the force-path characteristic curve is then qualitatively transferred from the static to the dynamic case. In the case of simplex brakes, there are two customary designs:
For brakes with the same normal force on both brake shoes 4, 5 (ideally fixed actuation, for example conventional S-cam brakes), the dynamic stiffness corresponds to the normal stiffness. The shear forces S on both brake shoes 4, 5 have the same magnitude, with one opposing the actuator and one acting with the actuator, thus canceling each other out.
For brakes with the same actuation force Fₐ on both brake shoes 4, 5 (for example, floating actuation or conventional hydraulic actuation), the normal force N on the leading brake shoe 4, 5 is higher than on the trailing brake shoe 5, 4. Thus, in total, a portion of the shear force S acts in the direction of the actuation force Fₐ, whereby the slope of the force-path characteristic curve is effectively reduced. If the ratio of the normal forces N is known from the substitute model, for example, the slope is calculated therewith. In particular, a simple analytical formula is used as the model, taking into account the ascertained friction value.

This ascertained dynamic force-path characteristic curve is preferably used as the starting point for the control of the drum brake 1. The optimization of the dynamic force-path characteristic curve by means of new measured values is preferably carried out continuously during operation of the motor vehicle, for example after each startup of the motor vehicle. In addition, by comparing the segments A1 and A7 in the air gap range, the non-force-dependent friction losses in the actuator assembly 6 can be deduced, provided that the spring force is considered negligible.

What is claimed is:

1. A method for operating an electromechanical drum brake, which includes at least two brake shoes, of a motor vehicle, the method comprising the following steps:
ascertaining a static force-path characteristic curve of the brake shoes for increasing and decreasing the braking force as a hysteresis curve when the motor vehicle is at a standstill;
ascertaining at least one stiffness and one friction value of at least one of the brake shoes as parameters as a function of a course of the static force-path characteristic curve;
ascertaining, as a function of the ascertained parameters, a dynamic force-path characteristic curve, using a physical substitute model of the drum brake; and
for satisfying a braking request, controlling the drum brake as a function of the dynamic force-path characteristic curve.

2. The method according to claim 1, wherein the electromechanical drum brake is a simplex brake or a duplex brake or a servo brake.

3. The method according to claim 1, wherein the static force-path characteristic curve is ascertained as a function of an actuation force and an actuation path of the brake shoes.

4. The method according to claim 3, wherein a motor current of an actuator assembly of the drum brake is monitored for determining the actuation force and/or a rotor position of the actuator assembly is monitored for determining the actuation path.

5. The method according to claim 1, wherein the braking force is increased and/or decreased by controlling the actuator assembly with a specified desired profile for the motor current, wherein the motor current is increased and/or decreased abruptly and/or has a modulated periodic component.

6. The method according to claim 1, wherein: (i) a stiffness in a normal direction, (ii) a stiffness in a tangential direction, and (iii) a friction value including a dynamic friction value and/or a static friction value, are ascertained as parameters.

7. The method according to claim 1, wherein a first point is selected for the static characteristic curve, and the braking force is increased only to the first point.

8. The method according to claim 7, wherein the first point is selected as a function of a maximum value of the actuation force, wherein the point is before the maximum value, in a region of at least approximately constant slope of the static force-path characteristic curve, and is mapped to the maximum value.

9. The method according to claim 7, wherein at least a second point is determined on the static force-path characteristic curve in a region of the braking force decrease, wherein the second point is mapped to a maximum gradient of a slope of the static force-path characteristic curve.

10. The method according to claim 9, wherein at least one of the parameters is ascertained as a function of the first and/or the second point.

11. The method according to claim 1, wherein at least one of the parameters is ascertained as a function of at least one distance: (i) between a pivot point of the brake shoes and a force application point of the actuator assembly and/or (ii) between a pivot point of the brake shoes and a contact point of the brake shoes with a brake drum of the drum brake.

12. The method according to claim 1, wherein an overall stiffness of the drum brake is ascertained, using the substitute model, as a function of ascertained stiffnesses of the brake shoes, and the dynamic force-path characteristic curve is ascertained as a function of the overall stiffness.

13. A control unit, configured to operate an electromechanical drum brake, which includes at least two brake shoes, of a motor vehicle, the control unit configured to:
ascertain a static force-path characteristic curve of the brake shoes for increasing and decreasing the braking force as a hysteresis curve when the motor vehicle is at a standstill;
ascertain at least one stiffness and one friction value of at least one of the brake shoes as parameters as a function of a course of the static force-path characteristic curve;
ascertain, as a function of the ascertained parameters, a dynamic force-path characteristic curve, using a physical substitute model of the drum brake; and
for satisfying a braking request, control the drum brake as a function of the dynamic force-path characteristic curve.

14. A drum brake of a motor vehicle, comprising:
at least two brake shoes;
an actuator assembly with an electric machine configured to displace the brake shoes; and
a control unit configured to operate the drum brake, which includes at least two brake shoes, the control unit configured to:
ascertain a static force-path characteristic curve of the brake shoes for increasing and decreasing the braking force as a hysteresis curve when the motor vehicle is at a standstill,
ascertain at least one stiffness and one friction value of at least one of the brake shoes as parameters as a function of a course of the static force-path characteristic curve,
ascertain, as a function of the ascertained parameters, a dynamic force-path characteristic curve, using a physical substitute model of the drum brake, and
for satisfying a braking request, control the drum brake as a function of the dynamic force-path characteristic curve.

15. The drum brake according to claim 14, wherein the drum brake is a simplex brake or a duplex brake or a servo brake.
